(19) United States
(12) Patent Application Publication
(10) Pub. No.: US 2008/0154905 A1
(43) Pub. Date: Jun. 26, 2008

(54) System, Method, Apparatus and Computer Program Product for Providing Content Selection in a Network Environment

(75) Inventors: Joonas Paalasmaa, Helsinki (FI); Antti Sorvari, Itasalmi (FI); Jukka-Pekka Salmenkaita, Helsinki (FI); Tomi Myllyla, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/614,168

(22) Filed: Dec. 21, 2006

(51) Int. Cl. G06F 7/00

(52) U.S. Cl. 707/10

(57) ABSTRACT

An apparatus for providing content selection in a network environment may include a processing element, a querying element and a selection element. The processing element may be configured to receive an instruction for performance of a function with respect to a particular file. The querying element may be configured to examine file association data associated with the particular file to determine whether one or more related files, each of which is a version of the particular file, exist at another location in a network. The selection element may be configured to select one of the one or more related files as a selected file. The processing element may be in communication with the querying and selection elements and may be further configured to instruct performance of the function with respect to the selected file.

### TECHNOLOGICAL FIELD

Embodiments of the present invention relate generally to content management technology and, more particularly, relate to a system, method, apparatus and computer program product for selecting content in a network environment.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to provision of information sharing in networks. For example, information such as audio, video, text, data, etc., may be shared between different entities using various communication networks. Accordingly, devices associated with each of the different entities may be placed in communication with each other to affect a transfer of the information. Additionally, within a particular network, one device may serve content to another device for rendering.

For any given network, each of the devices of the network may have different capabilities with respect to, for example, screen resolution, transfer speed, etc. Accordingly, mismatches between device capabilities and file characteristics may complicate rendering the particular file and lead to inefficiency or reduced enjoyment for consumers. For example, if a particular file which is relatively large and/or is of a relatively high quality is to be rendered on a device of limited screen size or limited resolution capabilities, some form of translation may be needed in order to render the file. Thus, the content may be processed for rendering very slowly such that the user may be dissatisfied with the performance. This may be particularly common when rendering multimedia content which may vary widely in terms of the characteristic described above.

Thus, it may be advantageous to provide an improved method of content management, which may overcome at least some of the disadvantages described above.

### BRIEF SUMMARY

A system, method, apparatus and computer program product are therefore provided to enable efficient content management. In particular, a method, apparatus and computer program product are provided that associate different versions of a particular file using, for example, metadata or other like identification. Thus, when a user attempts to render a particular file at a particular rendering device, embodiments of the present invention may determine an optimal file version from among known versions of the particular file based on context information, which may include capabilities of the rendering device or other factors. Accordingly, the efficiency of multimedia content rendering may be increased and content management for electronic devices such as mobile terminals may be improved.

Embodiments of the present invention may be utilized in, for example, a network such as a home network in which networked media devices that store, render and/or control audio visual content operate to form a universal plug and play audio visual environment.

In one exemplary embodiment, a method of providing file selection in a network environment is provided. The method includes receiving an instruction for performance of a function with respect to a particular file and examining file association data associated with the particular file to determine whether one or more related files, each of which is a version of the particular file, exist at another location in a network. The method may further include selecting one of the one or more related files as a selected file and instructing performance of the function with respect to the selected file.

In another exemplary embodiment, a computer program product for providing file selection in a network environment is provided. The computer program product includes at least one computer-readable storage medium having computer-readable program code portions stored therein. The computer-readable program code portions include first, second, third and fourth executable portions. The first executable portion is for receiving an instruction for performance of a function with respect to a particular file. The second executable portion is for examining file association data associated with the particular file to determine whether one or more related files, each of which is a version of the particular file, exist at another location in a network. The third executable portion is for selecting one of the one or more related files as a selected file. The fourth executable portion is for instructing performance of the function with respect to the selected file.

In another exemplary embodiment, an apparatus for providing file selection in a network environment is provided. The apparatus may include a processing element, a querying element and a selection element. The processing element may be configured to receive an instruction for performance of a function with respect to a particular file. The querying element may be configured to examine file association data associated with the particular file to determine whether one or more related files, each of which is a version of the particular file, exist at another location in a network. The selection element may be configured to select one of the one or more related files as a selected file. The processing element may be in communication with the querying and selection elements and may be further configured to instruct performance of the function with respect to the selected file.

In another exemplary embodiment, an apparatus for providing file selection in a network environment is provided. The apparatus includes means for receiving an instruction for performance of a function with respect to a particular file, means for examining file association data associated with the particular file to determine whether one or more related files, each of which is a version of the particular file, exist at another location in a network, means for selecting one of the one or more related files as a selected file and means for instructing performance of the function with respect to the selected file.

In another exemplary embodiment, a system for providing file selection in a network environment is provided. The system includes a first device configured to store a file, a second device configured to perform a function with respect to the file, and a control element in communication with both the first and second devices. The control element may include a processing element, a querying element and a selection element. The processing element may be configured to receive an instruction for performance of a function with respect to a particular file at the second device. The querying element may be configured to examine file association data associated with the particular file to determine whether one or more related files, each of which is a version of the particular file, exist at the first device. The selection element may be configured to select one of the one or more related files as a selected file. The processing element may be in communication with the querying and selection elements and may be further configured to instruct performance of the function with respect to the selected file.

Embodiments of the invention may provide a system, method, apparatus and computer program product for employment in systems to enhance content management and device rendering of content such as multimedia content. As a result, for example, mobile terminals and other electronic devices may benefit from an ability to perform content sharing in an efficient manner without suffering performance degradation. Additionally, optimal quality files may be utilized in content sharing.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of a system for providing content selection in a network environment according to an exemplary embodiment of the present invention;

FIG. 4 illustrates a block diagram of a content controller according to an exemplary embodiment of the present invention; and

FIG. 5 is a flowchart according to an exemplary method for providing content selection in a network environment according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

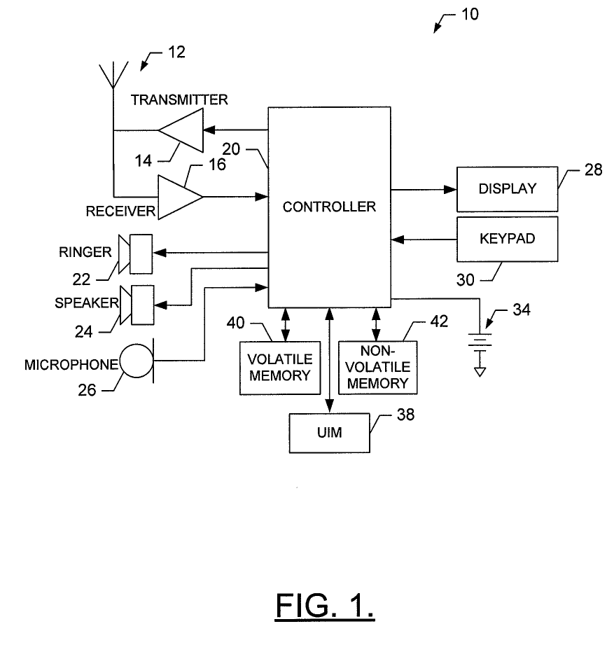

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

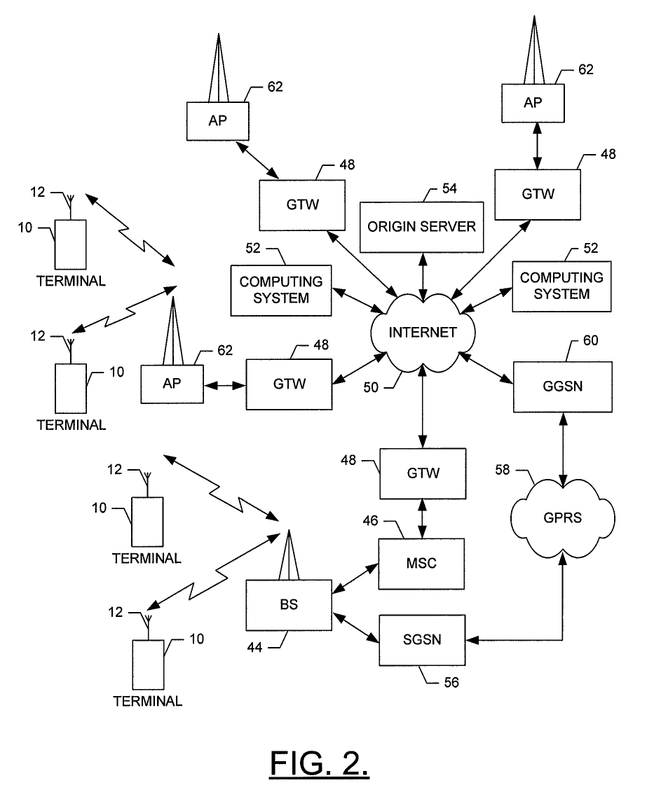

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX, UWB techniques and/or the like.

In an exemplary embodiment, content may be communicated over the system of FIG. 2 between a mobile terminal, which may be similar to the mobile terminal 10 of FIG. 1 and a network device of the system of FIG. 2, or between mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

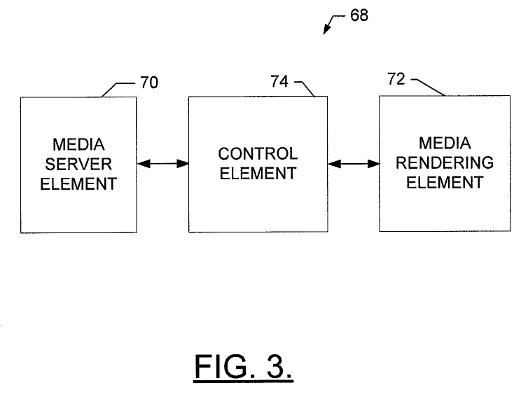

FIG. 3 illustrates a block diagram of a system for providing content selection in a network environment according to an exemplary embodiment of the present invention. Although the system could be a system similar to that shown in FIG. 2, the embodiment of FIG. 3 illustrates an exemplary embodiment in which the network environment is a home network. An exemplary embodiment of the invention will now be described with reference to FIG. 3, in which certain elements of a system for providing content selection in a network environment are displayed. The system of FIG. 3 will be described, for purposes of example, in connection with the mobile terminal 10 of FIG. 1 and the home network. However, it should be noted that the system of FIG. 3, may also be employed in connection with a variety of other devices, both mobile and fixed, and therefore, embodiments of the present invention should not be limited to application on devices such as the mobile terminal 10 of FIG. 1 or within home networks. In fact, embodiments may also be practiced in the context of public networks and may be practiced by various communication devices other than mobile terminals. It should also be noted, that while FIG. 3 illustrates one example of a configuration of a system for providing content selection in a network environment, numerous other configurations may also be used to implement embodiments of the present invention.

Referring now to FIG. 3, a system for providing content selection in a network environment is provided. The system, which in this case is embodied as a network 68 (which could be a home network), includes a media server element 70, a media rendering element 72 and a control element 74. The control element 74 may also be referred to as a control point. In general terms, it should be understood that, as used herein, the terms media server element, media rendering element and control element are used to denote that a particular device is performing a particular function corresponding to the media server element 70, the media rendering element 72 or the control element 74, respectively. As such, each of the media server element 70, the media rendering element 72 or the control element 74 may be defined in terms of their corresponding function with respect to the processing of a particular file or content item. In other words, each of the media server element 70, the media rendering element 72 or the control element 74 may be a logical device or application performing a corresponding role. Thus, for example, with reference to the rendering of a particular file, a single device could act as a media server element, while with reference to the rendering of a different file, the single device could act as a control element or a media rendering element. Furthermore, in some embodiments the single device could act as any one or even all of the media server element 70, the media rendering element 72 and the control element 74. Communication between the media server element 70, the media rendering element 72 and the control element 74 may be either via a wired or wireless connection. In other words, all or portions of the network 68 could be formed as a wireless network or a wired network.

It should be noted that although the network 68 of FIG. 3 is shown to include only one of each of the media server element 70, the media rendering element 72 and the control element 74, it is possible that more than one of each of the media server element 70, the media rendering element 72 or the control element 74 may be included in the network 68. It should also be noted that the control element 74 need not necessarily be disposed between the media server element 70 and the media rendering element 72 as shown in FIG. 3. Rather, the media server element 70 and the media rendering element 72 may be in communication with each other directly or via another device not shown in FIG. 3. As such, it should be understood that the elements of FIG. 3 are provided as a simple example in order to facilitate explanation of an embodiment of the invention and such elements are not provided for purposes of limitation.

The media server element 70 may be any device or means embodied in either hardware, software, or a combination of hardware and software that is capable of serving content to another device. In this regard, the media server element 70 may include or otherwise be configured to access a memory device configured to store information such as files which may include, for example, multimedia content. In an exemplary embodiment, the media server element 70 may be configured to store media files and, via communication with other devices, may be configured to make the stored media files accessible to other devices for upload to the other devices. The Hyper Text Transfer Protocol (HTTP) may be utilized, for example, to communicate the stored media files to the other devices via a network such as the home network. In an exemplary embodiment, the media server element 70 could be a mobile terminal such as the mobile terminal 10 of FIG. 1, the origin server 54, or the computing system 52 of FIG. 2 or any other communication device that is configured to serve content to other devices. The media server element 70 could alternatively simply be a storage device or an application in communication with a storage device and configured to enable access to files stored in the storage device.

The media rendering element 72 may be any device or means embodied in either hardware, software, or a combination of hardware and software that is capable of rendering content. In this regard, the media rendering element 72 may include, for example, a display, speakers or any other mechanism by which content may be rendered. As such, the media rendering element 72 may be any device configured to render information such as files which may include, for example, multimedia content. In other words, the media rendering element 72 may be configured to, for example, play music, play video, display images, etc. In an exemplary embodiment, the media rendering element 72 could be a mobile terminal such as the mobile terminal 10 of FIG. 1 or any other communication device that is configured to render content such as, for example, a television, a digital video recorder, a personal video recorder, a computer, etc.

The control element 74 may be any device or means embodied in either hardware, software, or a combination of hardware and software that is capable of controlling the transfer of files between devices such as media server elements and media rendering elements. In an exemplary embodiment, the control element 74 could be a mobile terminal such as the mobile terminal 10 of FIG. 1 or any other communication device that is configured to enable control over file transfer within the network 68. The control element 74 could alternatively be embodied, for example, as an application configured to manage file transfers within the network 68. In an exemplary embodiment, the control element 74 may be configured to query media servers in response to receipt of a user instruction to transfer and/or render a particular file. In this regard, the query may be directed to locating files associated with the particular file by virtue of being related to the particular file. For example, the files associated with the particular file may be different versions of the particular file. In response to the querying of the media servers, the control element 74 may be configured to establish a list of related files associated with the particular file. The list may then be presented to a user for selection of a desired file, or an optimal or selected file may be automatically selected by the control element 74 based on predefined rules and the selected file may then be transferred or served to the media rendering element 74 accordingly instead of the particular file. In an exemplary embodiment, when a particular file is selected by the control element 74, the control element 74 may command the media rendering element 72 to fetch the selected file from the media server element 70 identified as having the selected file. For example, the control element 74 may direct the media rendering element 72 to access and render the selected file by identifying a uniform resource identifier (URI) of the selected file.

In this regard, each media file in the network 68 may be identified by a particular identifier such as a URI. Each media file may also be accessed using the identifier from devices in communication with the network 68, for example, via HTTP. In an exemplary embodiment, each media file may also include file association data. The file association data of a particular file may identify the identifier of each corresponding file that is associated with the particular file. Accordingly, the file association data, which may be metadata for example, may be used to associate different versions of the same file or otherwise identify files belonging to a file family of related files. For example, if a particular file is uploaded or otherwise stored at a device on the network such as a personal computer or a storage server, the particular file may have, e.g., a high resolution. A user may, for example, decide to transfer the file to the mobile terminal 10, which may downsample the original file to conserve memory space. The downsampled file and the original file (i.e., the particular file), despite having different identifiers, would be related as different versions of the same file. As such, embodiments of the present invention may provide a mechanism by which to associate the original file, the downsampled file and, if applicable, other versions of the file that may be associated with the original file.

File associations may be made a number of different ways. In an exemplary embodiment, whenever a version of an original file is created, metadata including the identifier or URI of the original file may be stored in association with the created version. For example, when the original file is downsampled, the control element 74 may save metadata including the URI of the original file in association with the URI of the downsampled file. The metadata may be saved, for example, to a memory device. Alternatively, metadata including the URI of the original file may be stored in the downsampled file. In other words, with respect to an original file, whenever a version is created, the control element 74 may store file association data either in a location accessible to the control element 74, or within the created version itself. In situations where each file includes metadata, in response to uploading any file, the control element 74 may be configured to examine the uploaded file for file association data and store any file association data that may be determined from the file, for example, in a database or memory device accessible to the control element 74.

File association data may be inserted into a file or communicated to the control element 74 by either a device uploading or downloading the file (e.g., the media server element 70 or the media rendering element 72). The control element 74 may then store file association information which associates files in a particular file family that may include all versions of the same file, for example, in a database or table accessible to the control element 74. Alternatively, the file association data may be inserted into a file or determined by the control element 74 itself. Accordingly, if the file association data is accessed from file association information that is stored at a network location accessible to the control element 74, it will be appreciated that the control element 74 can perform file associations for files on any device in communication with the network 68. However, if the file association data is stored in the file itself, files may be transferred across networks such as the internet and file associations may be made over a public network as well.

File association data may be updated each time a particular file is identified for rendering at another device in response to querying stored files for file association data identifying files as being related to the particular file. Alternatively, file association data may be updated whenever a version of a file is created such as by a transfer of the file between devices. When a different version is created, the different version may include file association data identifying the particular file. In one exemplary embodiment, the file association data may always include an identifier of the original file from which each existing version is based. As a result, each version, regardless of which other version may have been used in creation of the version, may include a reference to the same file (e.g., the original file) in order to simplify file association. Alternatively, file association data for a given file may include metadata identifying the preceding file or version used to create the given file. The preceding file may then be examined for metadata identifying its corresponding preceding file and so on. In order to ensure that all versions related to an original file are detected, file association data may also identify versions created from the given file and each other file. Accordingly, file versions in different branches of a family of files may also be identified as being related to the given file. In an exemplary embodiment, standards such as a universal plug and play (UPnP) AV 3.0 and/or DLNA 2.0 standard could be defined relating to tracking file associations. Additionally or alternatively, UPnP AV 3.0 and/or DLNA 2.0 synchronization standards may be developed to provide, for example, hash values derived from file content. Accordingly, if hash values are used to identify content, different versions of the same content would have different hash values. However, a hash value of the original file could be used as the metadata or file association data used for identifying related files.

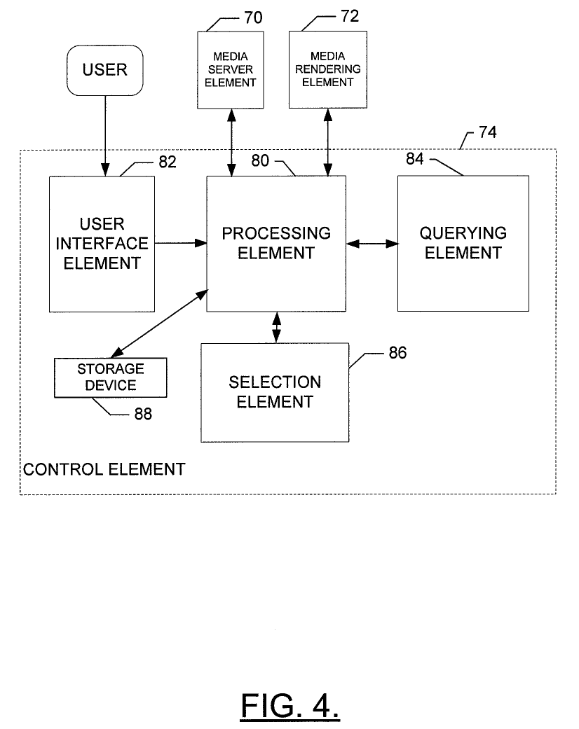

FIG. 4 illustrates a block diagram of the control element 74 according to one exemplary embodiment. As shown in FIG. 4, the control element 74 may include a processing element 80 which may execute instructions for performance of the functions associated with the control element 74 and/or otherwise control various elements of the control element 74. The processing element 80 may also provide instructions to devices acting as the media server element 70 and/or the media rendering element 72 regarding file transfer and/or rendering operations. Processing elements as described herein may be embodied in many ways. For example, the processing element 80 may be embodied as a processor, a coprocessor, a controller or various other processing means or devices including integrated circuits such as, for example, an ASIC (application specific integrated circuit). The control element 74 may also include may also include a memory device 88, which could be, for example, either the volatile memory 40 or the non-volatile memory 42 of the mobile terminal 10.

In an exemplary embodiment, the control element 74 may further include a user interface element 82, a querying element 84, and a selection element 86 each of which may operate under the control of or otherwise be embodied as the processing element 80. Communication between each of the elements of the control element 74 may be conducted through the processing element 80 as shown in FIG. 4 or, alternatively, some or all of the elements of the control element 74 may be in direct communication with each other.

The user interface element 82 may be any device or means embodied in either hardware, software, or a combination of hardware and software that is capable of providing information to a user and/or accepting information or instructions from the user. In this regard, for example, the user interface element 82 may include, for example, a keyboard, keypad, function keys, mouse, scrolling device, touch screen, display, speaker, microphone, or any other mechanism by which a user may interface with the control element 74. The user interface element 82 may be configured to receive instructions from the user regarding transfer and/or rendering of a particular file, for example, at a particular media rendering element. In an exemplary embodiment, the user may utilize the user interface element 82 in order to search for or otherwise locate a particular file for transferring and/or rendering. An identifier of the particular file may then be communicated to the querying element 84.

The querying element 84 may be any device or means embodied in either hardware, software, or a combination of hardware and software that is capable of determining which files are associated with a particular file based on file association data corresponding to the particular file. For example, the processing element 80 may include and function as the querying element 84 as noted above. In an exemplary embodiment, the querying element 84 may be configured to query each media server element in communication with the network 68 for files related to a particular file that may be identified by the user interface element 82 for transfer and/or rendering. For example, in response to receipt of the identifier of the particular file, the querying element 84 may be configured to query each media server element in communication with the network 68 in order to determine if any files include or are otherwise associated with file association data related to the identifier of the particular file. Alternatively, rather than executing the query in response to receipt of the identifier, the querying element may be configured to perform sweeps for files within the network in order to generate file association information related to the files within the network on a routine and/or periodic basis. As such, in response to receipt of the identifier of the particular file, the querying element 84 may merely reference stored file association information related to the identifier of the particular file. Additionally, a third party service such as an Internet search engine could be used in finding versions of a file located on the Internet. Thus, for example, for a video stored at the mobile terminal 10, which does not have a restrictive license associated with it, another publicly accessible version of the file may be accessed.

In an exemplary embodiment, a corresponding identifier of each file associated with a particular file may be stored in association with the identifier of the particular file, for example, in the storage device 88, which may either be a portion of the control element 74 (as shown in FIG. 4) or otherwise be in communication with the control element 74, as file association information. The file association information may include, for each identifier, a list of corresponding identifiers of related files. In an exemplary embodiment, the querying element 84 may also be configured to communicate the corresponding identifier of each file associated with the particular file to the selection element 86 for processing at the selection element 86 as described in greater detail below.

The selection element 86 may be any device or means embodied in either hardware, software, or a combination of hardware and software that is capable of enabling selection of an optimal file version as a selected file and directing substitution of the selected file in replacement of the particular file for rendering at the media rendering element 72. For example, the processing element 80 may include and function as the selection element 86 as noted above. In an exemplary embodiment, the selection element 86 may be configured to select the selected file based on the context in which the particular file is to be rendered, as determined by the control element 74. For example, the selection element 86 may be configured to automatically select the selected file based at least in part on the capabilities of the media rendering element 72 and/or based on a communication connection between the media server element 70 and the media rendering element 72. The automatic selection may be based at least in part upon predefined rules. As an alternative, the selection element 86 may be configured to present a list of files associated with the particular file to the user to enable the user to select one of the files of the list as the selected file.

In operation, the selection element 86 may receive the corresponding identifier of each file associated with the particular file and determine operational characteristics related to each file associated with the particular file. For example, the selection element 86 may determine operational characteristics such as information defining a size of the file (e.g., image or video pixel size), image quality, video quality, track quality, video or audio (e.g., music, podcast) bitrate, video or audio codec, estimated transfer speed (or time) for a transfer from the media server element 70 to the media rendering element 72, screen resolution of the media rendering element 72, battery status, etc.

According to one exemplary embodiment, based at least in part on the operational characteristics related to each file associated with the particular file, the selection element 86 may be configured to select one file automatically based on predefined rules. The predefined rules may be stored, for example, at the selection element 86 or at a location otherwise accessible to the selection element 86. The predefined rules may, for example, be device specific. In other words, the selection element 86 may access predefined rules based on either one or both of the media server element 70 and the media rendering element 72. In an exemplary embodiment, the predefined rules may assign a priority to particular operational characteristics for each type of device. For example, for a resource constrained device such as the mobile terminal 10, the predefined rules may define a high priority for smaller file size and a low priority for files having a large file size. Alternatively, if content (e.g., the particular file) is to be remotely accessed from the network 68, a cost may be associated with bandwidth consumed for transferring the content. Accordingly, a priority may be placed on fast transfer time in order to reduce the cost of executing the transfer. As another alternative, for example, a rule may specify that battery operated devices should be avoided as media servers in order to reduce batter consumption of such devices. Other similar rules and/or priority assignments may be made for various devices based upon user preferences, which may be entered, for example, via the user interface element 82, or based upon predefined rules that are installed by, received from, or otherwise determined by a network operator or other entity.

In an alternative exemplary embodiment, rather than automatically selecting the selected file based upon predefined rules, the selection element 86 may present the list of files associated with the particular file to the user via the user interface element 82 to enable the user to select the selected file. The selection element 86 may also provide some or all of the operational characteristics for display to the user for the user's consideration in selecting the selected file. In an exemplary embodiment, based on user preferences, the list of files associated with the particular file may be ordered with respect to one or more of the operational characteristics. In another exemplary embodiment, only a portion of the list of files may be presented to the user based on priority and/or rules associated with the files.

Upon receipt of either the automatic or user selection of the selected file, the selection element 86 may substitute the selected file for the particular file and communicate or otherwise direct communication of the selected file to the media rendering element 72. In other words, in response to a user selection of a particular file for transfer and/or rendering at a particular device, the control element 74 may be configured to select and substitute a version of the particular file for communication to the particular device for transfer and/or rendering. The selection may be based at least in part on operational characteristics associated with the transfer and/or rendering of each potential substitute file (e.g., each version of the particular file) and/or based on capabilities of the particular device. The selection may be automatic based upon predefined rules or may be made by the user. In order to execute the substitution, the control element 74 may, for example, direct the media rendering element 72 to fetch the selected file from the media server element 70 at which the selected file is stored.

In certain situations, where the media server element 70 may not be currently accessible via the network 68, upon selection of the selected file, the control element 74 may be configured to issue a wakeup command to the media server element 70 in an effort to wake the device corresponding to the media server element 70. If the effort to wake the media server element 70 is unsuccessful, or if the media server element 70 is otherwise determined to be inaccessible, the control element 74 may be configured to select a replacement file. The replacement file may be a file determined by the control element 74 to be substituted for the selected file if the selected file is not accessible. In an exemplary embodiment, priority order and/or the predefined rules described above may be utilized in order to determine which file should be determined as the replacement file.

Although the description above has primarily described rendering of a file at a rendering device, embodiments of the present invention may also or alternatively be employed in a transferring and/or copying context. For example, if a particular file is selected for copying from a first device (e.g., the media server element 70) to a second device (e.g., another media server), it may be desirable to copy instead a selected file which is a higher quality version of the particular file. Accordingly, since the second device may downsample during creation of the file to be stored at the second device, it may be preferable to downsample from a higher quality version of the particular file. Thus, embodiments of the present invention may be configured to substitute a higher quality version of the particular file for copying of data (and subsequent downsampling) in order to create a new version at the second device.

It should also be recognized that if a copying operation is desired in which a downsampled file on the first device which is resource constrained is to be copied to the second device which is not resource constrained, it may be desirable to identify a selected file which is a version of the downsampled file that is higher quality than the downsampled file. The selected file may then be used to produce a higher quality copy at the second device.

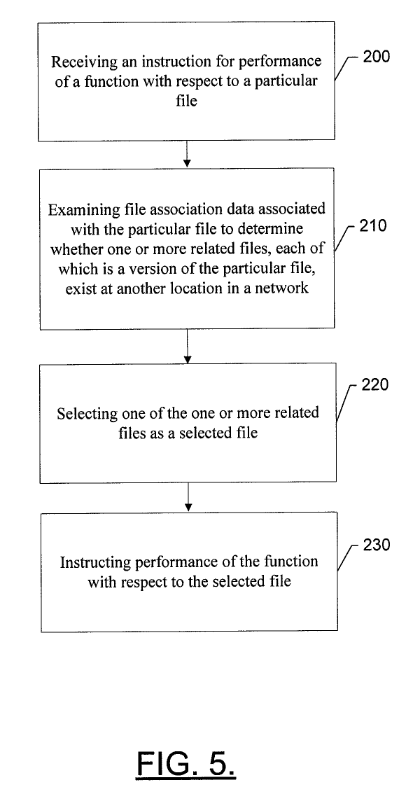

FIG. 5 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal and executed by a built-in processor in a mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing content selection in a network environment may include receiving an instruction for performance of a function with respect to a particular file at operation 200. In an exemplary embodiment, operation 200 may include receiving an instruction to create a copy of the particular file at a location different than a location of the particular file or receiving an instruction to render the particular file at a rendering device. At operation 210, file association data associated with the particular file may be examined to determine whether one or more related files, each of which is a version of the particular file, exist at another location in a network. It should be noted that the particular file is itself one of the one or more related files. In an exemplary embodiment, operation 210 may include examining file association data stored in association with an identifier of the particular file or examining file association data stored in the particular file. One of the one or more related files may be selected as a selected file at operation 220. Operation 220 may include selecting the selected file based at least in part on a comparison of operational characteristics of the particular file and each of the one or more related files. Alternatively, operation 220 may include automatically selecting the selected file based at least in part on predefined rules or selecting one of the one or more related files as the selected file comprises selecting the selected file responsive to a user input. The method may also include instructing performance of the function with respect to the selected file at operation 230. In an exemplary embodiment, operation 230 may include instructing copying the selected file to the location different than the location of the particular file or instructing rendering the selected file at the rendering device. According to another exemplary embodiment, the method may further include performing a periodic scan of files on the network to examine file association data for each of the files, and storing file association information associating each of the files with corresponding related files.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an instruction for performance of a function with respect to a particular file;
examining file association data associated with the particular file to determine whether one or more related files, each of which is a version of the particular file, exist at another location in a network;
selecting one of the one or more related files as a selected file; and
instructing performance of the function with respect to the selected file.

2. A method according to claim 1, wherein receiving an instruction for performance of the function comprises receiving an instruction to create a copy of the particular file at a location different than a location of the particular file and wherein instructing performance of the function comprises instructing copying the selected file to the location different than the location of the particular file.

3. A method according to claim 1, wherein receiving an instruction for performance of the function comprises receiving an instruction to render the particular file at a rendering device and wherein instructing performance of the function comprises instructing rendering the selected file at the rendering device.

4. A method according to claim 1, wherein examining the file association data comprises examining file association data stored in association with an identifier of the particular file.

5. A method according to claim 1, wherein examining the file association data comprises examining file association data stored in the particular file.

6. A method according to claim 1, further comprising:
performing a periodic scan of files on the network to examine file association data for each of the files; and
storing file association information associating each of the files with corresponding related files.

7. A method according to claim 1, wherein selecting one of the one or more related files as the selected file comprises selecting the selected file based at least in part on a comparison of operational characteristics of the particular file and each of the one or more related files.

8. A method according to claim 1, wherein selecting one of the one or more related files as the selected file comprises automatically selecting the selected file based at least in part on predefined rules.

9. A method according to claim 1, wherein selecting one of the one or more related files as the selected file comprises selecting the selected file responsive to a user input.

10. A computer program product comprising at least one computer-readable storage medium having computer-readable program code portions stored therein, the computer-readable program code portions comprising:
a first executable portion for receiving an instruction for performance of a function with respect to a particular file;
a second executable portion for examining file association data associated with the particular file to determine whether one or more related files, each of which is a version of the particular file, exist at another location in a network;
a third executable portion for selecting one of the one or more related files as a selected file; and
a fourth executable portion for instructing performance of the function with respect to the selected file.

11. A computer program product according to claim 10, wherein the first executable portion includes instructions for receiving an instruction to create a copy of the particular file at a location different than a location of the particular file and wherein performing the function comprises copying the selected file to the location different than the location of the particular file.

12. A computer program product according to claim 10, wherein the first executable portion includes instructions for receiving an instruction to render the particular file at a rendering device and wherein performing the function comprises rendering the selected file at the rendering device.

13. A computer program product according to claim 10, wherein the second executable portion includes instructions for examining file association data stored in association with an identifier of the particular file.

14. A computer program product according to claim 10, wherein the second executable portion includes instructions for examining file association data stored in the particular file.

15. A computer program product according to claim 10, further comprising:
a fifth executable portion for performing a periodic scan of files on the network to examine file association data for each of the files; and
a sixth executable portion for storing file association information associating each of the files with corresponding related files.

16. A computer program product according to claim 10, wherein the third executable portion includes instructions for selecting the selected file based at least in part on a comparison of operational characteristics of the particular file and each of the one or more related files.

17. A computer program product according to claim 10, wherein the third executable portion includes instructions for automatically selecting the selected file based at least in part on predefined rules.

18. A computer program product according to claim 10, wherein the third executable portion includes instructions for selecting the selected file responsive to a user input.

19. An apparatus comprising:
a processing element configured to receive an instruction for performance of a function with respect to a particular file;
a querying element configured to examine file association data associated with the particular file to determine whether one or more related files, each of which is a version of the particular file, exist at another location in a network; and
a selection element configured to select one of the one or more related files as a selected file,
wherein the processing element is in communication with the querying and selection elements and is further configured to instruct performance of the function with respect to the selected file.

20. An apparatus according to claim 19, wherein the processing element is configured to receive an instruction to create a copy of the particular file at a location different than a location of the particular file and enable copying the selected file to the location different than the location of the particular file.

21. An apparatus according to claim 19, wherein the processing element is configured to receive an instruction to render the particular file at a rendering device and enable rendering the selected file at the rendering device.

22. An apparatus according to claim 19, wherein the querying element is further configured to examine file association data stored in association with an identifier of the particular file.

23. An apparatus according to claim 19, wherein the querying element is further configured to examine file association data stored in the particular file.

24. An apparatus according to claim 19, wherein the querying element is further configured to:
perform a periodic scan of files on the network to examine file association data for each of the files; and
store file association information associating each of the files with corresponding related files.

25. An apparatus according to claim 19, wherein the selection element is configured to select the selected file based at least in part on a comparison of operational characteristics of the particular file and each of the one or more related files.

26. An apparatus according to claim 19, wherein the selection element is configured to automatically select the selected file based at least in part on predefined rules.

27. An apparatus according to claim 19, wherein the selection element is configured to select the selected file responsive to a user input.

28. An apparatus according to claim 19, wherein the apparatus is embodied as a mobile terminal.

29. An apparatus comprising:
means for receiving an instruction for performance of a function with respect to a particular file;
means for examining file association data associated with the particular file to determine whether one or more related files, each of which is a version of the particular file, exist at another location in a network;
means for selecting one of the one or more related files as a selected file; and
means for instructing performance of the function with respect to the selected file.

30. An apparatus according to claim 29, further comprising:
means for performing a periodic scan of files on the network to examine file association data for each of the files; and
means for storing file association information associating each of the files with corresponding related files.

31. A system comprising:
a first device configured to store a file;
a second device configured to perform a function with respect to the file; and
a control element in communication with both the first and second devices, the control element comprising:
a processing element configured to receive an instruction for performance of a function with respect to a particular file at the second device;
a querying element configured to examine file association data associated with the particular file to determine whether one or more related files, each of which is a version of the particular file, exist at the first device; and
a selection element configured to select one of the one or more related files as a selected file,
wherein the processing element is further configured to instruct performance of the function with respect to the selected file.

32. A system according to claim 31, wherein the querying element is further configured for:
performing a periodic scan of files on the network to examine file association data for each of the files; and
storing file association information associating each of the files with corresponding related files.
